(19) United States
(12) Patent Application Publication
(10) Pub. No.: US 2003/0193950 A1
(43) Pub. Date: Oct. 16, 2003

(54) Method and apparatus for efficient transmission of VoIP traffic

(76) Inventors: David Philips, Holon (IL); Oleg Litvak, Ariel (IL)

Correspondence Address: COOLEY GODWARD, LLP, 3000 EL CAMINO REAL, 5 PALO ALTO SQUARE, PALO ALTO, CA, 94306, US

(21) Appl. No.: 10/413,857

(22) Filed: Apr. 14, 2003

(30) Foreign Application Priority Data
Apr. 15, 2002 (IL) 149165

(51) Int. Cl. H04L 12/28

(52) U.S. Cl. 370/392; 370/471

(57) ABSTRACT

A communication protocol is disclosed which comprises the use of a communication frame adapted to be used as a UDP payload. The communication frame comprise a plurality of mini packets, where at least some of the mini packets comprise a composite header and a data packet, where the composite header comprises a mini header with an identification of a user associated with a data packet; a flag indicating whether the protocol header is in a compressed mode or is in a transparent mode; an indication of the length of the mini packet; and a protocol header.

### FIELD OF THE INVENTION

The present invention relates to efficient transmission of IP telephony signals between media-gateways by multiplexing signals of several channels into a single IP packet, thus reducing the transmission overhead per each channel.

### BACKGROUND OF THE INVENTION

The fast growth of the INTERNET has stimulated the development of IP networks. At present there is a clear trend to use IP networks not only for INTERNET traffic but to provide all telecommunication services using this infrastructure. One of these applications is transmission of telephony traffic over IP networks by converting the telephony traffic to IP packets. This application allows one Public-Switched Telephone Network (PSTN) subscriber to call another PSTN subscriber each connected through Voice over IP (to be referred to herein as “VoIP”) media-gateway to the INTERNET, eliminating the need for long distance telephone network.

In a VoIP telephony connection, two sides of the PSTN network are interconnected by VoIP media-gateways. In such an application, the telephony signals are converted into IP packets using a Real-time Transport Protocol (“RTP”)/User Datagram Protocol (“UDP”)/Internet Protocol(“IP”), RTP/UDP/IP, connection. RTP is an Internet protocol for transmission of real-time data such as audio and video. RTP itself does not guarantee real-time delivery of data, e.g. retransmission of undelivered packets, but it does provide mechanisms for sending and receiving applications to support streaming data. Typically, RTP runs on top of the UDP protocol. UDP is a connectionless protocol that, like TCP, runs on top of IP networks. Unlike TCP/IP, UDP/IP provides very few error recovery services, offering instead a direct way to send and receive datagrams over an IP network. In addition to RTP carrying VoIP packets, UDP is used to transmit other telephony signals such as digitized facsimile signals according to ITU Recommendation T.38.

VoIP media-gateways provide an interface between existing TDM based networks and packet switched IP data networks. For example, in a VoIP application the voice samples are compressed using a compression algorithm such as G.729. This algorithm is operative to convert a block of 80 voice samples (10 msec) into a compressed signal of 10 bytes. Typically, two consecutive blocks of compressed voice (20 bytes) are transmitted in one IP packet every 20 msec interval. As will be appreciated, small size packets are subjected to large overhead when transferred using the Real time Transport Protocol (RTP), as the RTP/UDP/IP overhead is 40 bytes (12+8+20) for a simple speech packet. For example, for a 20 byte packet transferred via RTP/UDP/IP the overhead presents 67% of the packet (40 byte overhead/(40+20) byte in a packet). In addition, for each voice channel a single UDP/IP connection (a pair of UDP ports) is established between the media-gateways. This requires significant resources at each media-gateway and generates many small size packets on the IP network.

It is therefore desired to reduce the relative overhead per each voice packet and reduce the total number of packets to be processed by the media-gateways and the IP network. It can be appreciated that there is a need for a method and apparatus for eliminating inefficiencies in transporting short packets between IP telephony media-gateways connected by an IP network.

A method for transmission of multiple voice packets over a single RTP/UDP/IP connection is disclosed in PCT patent application WO 00/11849. By this method, a number of voice packets are packed into one RTP payload. Each small voice packet (called a mini-packet) is preceded by a 2-byte header (called a mini-IP header). The information in the mini-IP header comprises: a one-byte Channel Identifier—CID, a six-bit length indicator—LI, and a two-bit sequence number—SN. The CID, which is used to identify the voice channels, is established through a negotiation process between the media-gateways during the connection setup, whereas the LI is used to indicate the length of the mini-packet. However there are some disadvantages associated with this method. First, it does not provide transparency of information that exists in the RTP header of each original voice packet as the original CID in the UDP header comprises two bytes instead of the one by this method. Also the RTP header comprises a time-stamp which is not transmitted in accordance with this method. Transparent transmission of the RTP header information is very important and it also simplifies the communication as no translation or reconstruction of information is required. On the other hand, it is important that this transparency should not significantly reduce the transmission efficiency of the voice packet over an IP network.

Another method for multiplexing several VoIP channels over a single IP connection is disclosed in a draft proposal to the IETF “draft-tanigawa-rtp-multiplex-01.txt” entitled “Simple RTP Multiplexing Transfer Methods for VoIP”, and dated Nov. 18, 1998. This document describes a method to reduce the IP-UDP header overhead of RTP streams by concatenating RTP packets sharing the same Internet telephony media-gateway destination, into a single UDP packet, wherein a number of RTP packets, each comprising an RTP header and an RTP payload, are connected to form the UDP payload. Although this publication teaches how to increase the efficiency of bandwidth utilization, this efficiency is limited, and one of the major drawbacks is that the user should be identified by the SSRC value of the RTP header, which is a random number.

A further method for multiplexing several VoIP channels over a single IP connection is disclosed in a draft proposal to the IETF “draft-ietf-avt-tcrtp-06.txt” entitled “Tunneling Multiplexed Compressed RTP (“TCRTP”)” and dated Feb. 27, 2002. This document describes a method to improve the end-to-end bandwidth utilization of RTP streams over an IP network using compression and multiplexing. The improvement is accomplished by combining three standard protocols: Enhanced CRTP for header compression, ppp Multiplexing [PPP-MUX] for multiplexing of several data packets over a single IP packet and L2TP tunneling [L2TP] for transmission of PPP over an IP network. However, major drawbacks of this method are that it requires implementation of complex state machines that must be synchronized at both ends of the IP network and it is not fully optimized for IP telephony applications.

The disclosure of the references mentioned throughout the present specification are hereby incorporated by reference.

### SUMMARY OF THE INVENTION

To overcome the limitations in the prior art described above, and to overcome other limitations that will become apparent upon reading and understanding the present specification, it is the object of the present invention to provide an efficient real-time transport protocol multiplexing method and apparatus for transporting compressed speech and other telephony or multi-media services between IP telephony media-gateways.

The present invention solves the above-described problems by providing a method and apparatus for eliminating inefficiencies in transporting short packets between IP telephony media-gateways connected by an IP network, while the method and apparatus provided by the present invention enable a number of users to share a single UDP/IP connection.

Further objects and features of the invention will become apparent to those skilled in the art from the following description and the accompanying drawings.

In accordance with an embodiment of the present invention there is provided a communication protocol comprising communication frames that are adapted to be used as a UDP payload. At least some of the communication frames comprise a plurality of mini packets, wherein each of the mini packets comprises:

a composite header which comprises:

a mini header which comprises:

an identification of a user associated with a data packet;

a flag indicating whether the protocol header is in a compressed mode or is in a transparent mode; and

an indication of the length of said mini packet; and

a protocol header; and

a data packet.

Preferably, each of the communication frames comprises a plurality of mini packets having the structure described.

According to another preferred embodiment of the invention, al least one of the communication frames adapted to be used as a UDP payload, further comprises at least one frame header (e.g. an RTP header) which may be used to carry information that relates to the proceeding various mini packets which follow that frame header.

By a preferred embodiment of the invention, the identification of a user in each of the plurality of mini packets is a 2 byte long channel ID, the flag is one bit long and the length indicator (LI) is 12 bits long. Preferably, the identification of a user associated with a data packet comprises the number of the port through which this data packet is transmitted.

According to a preferred embodiment of the invention, a communication frame may comprise at least one mini packet having a protocol header of a transparent mode. In such a mode, the protocol header is a member selected from the group consisting of: an RTP header, an RTCP header, a T.38 header and a header of traffic of the type Modem over IP (MoIP). In a preferred example, the protocol header is an RTP header as defined in IETF RFC 1889 and in IETF RFC based on draft “draft-ietf-avt-rtp-new-11.txt” of Nov. 20, 2001.

According to another preferred embodiment of the invention, a communication frame may comprise at least one mini packet having a protocol header of a compressed mode. In such a compressed mode, the protocol header comprises an indication of a sequential number of a data packet associated therewith and an indication of time in which said data packet is transmitted. Preferably, the packet sequence number indicator is less than 16 bits long, more preferably, it is 12 bits long. By another embodiment, the time stamp indicator is less than 32 bits long, more preferably, it is 20 bits long.

By yet another preferred embodiment, the data packet sequence number indicator comprises the least significant bits of the data packet sequence number and the time stamp indicator comprises the least significant bits of the data packet timestamp.

By still another embodiment of the invention, the mode of each of the protocol headers of the plurality of mini packets comprising such a communication frame is determined by the following criteria:

a protocol header of the mini packet transmitted at a beginning of a communication session, shall be transmitted in a transparent mode;

whenever the information in a protocol header is different only in the sequence number and time stamp from the information included in the protocol header of the preceding mini packet and received from the same user, the protocol header shall be transmitted in a compressed mode;

if mini packets associated with a user were all transmitted for a predetermined time with their protocol headers being in a compressed mode, the protocol header of the proceeding mini packet shall be transmitted in a transparent mode.

In accordance with yet another embodiment of the invention, there is provided a method for increasing bandwidth usage efficiency of an IP network, which comprises:

creating a composite header comprising a mini header and a protocol header for each of a plurality of data packets, each mini header providing identification of a user associated with a data packet;

adding each composite header to the data packet associated therewith to form a mini packet;

multiplexing a plurality of mini packets into a UDP payload; and

transmitting the UDP payload over a single UDP/IP connection.

Preferably, the plurality of data packets are received from two or more users.

By another embodiment, the identification of a user further comprises a unique channel identifier for each of the two or more users. More preferably, the channel identifier is assigned to packets transmitted from a user when the user requests access to the IP network.

According to still another embodiment of the invention, the data packet comprises voice information. The term “voice” as used herein, is used to denote voice signals as well as voice-related traffic. Such signals could be voice signals, facsimile signals, voiceband data signals such as modem, DTMF and the like signals, signals used for signaling, etc. The term “VoIP” or IP telephony as used herein is used to denote the transport of packetized voice and also includes enhanced services and complex infrastructure. It includes among others, PC-to-PC, PC-tophone, and phone-to-phone applications whether the call transaction rides over the public Internet, the PSTN, or a private Internet connection such as an IP VPN. This term should be understood to include voice over IP as explained above but also voice over ATM, voice over frame relay, voice over DSL, voice over cable, voice over broadband, and the like.

Another preferred use of the present invention is for transmitting facsimile communication, in which case at least one of the plurality of data packets within the communication frame described, is a data packet that is compatible with ITU Recommendation T.38 and carries facsimile signals.

According to another embodiment of the invention the composite header of each data packet multiplexed into said UDP payload is transparent to intermediate IP routers.

By another embodiment, the method provided further comprises the step of de-assembling the UDP payload back into the data packets.

In accordance with another aspect of the present invention there is provided an IP network, comprising:

a remote VoIP media-gateway; and

a local VoIP media-gateway;

wherein the remote and local VoIP media-gateways communicate using a protocol, the protocol comprising:

creating a composite header comprising a mini header and a protocol header for each of a plurality of data packets received from a plurality of users at the local VoIP media-gateway, each composite header providing identification of a user associated with a packet;

adding each composite header to the data packet associated therewith to form mini packets; multiplexing the mini packets into a UDP payload; and

transmitting the UDP payload over a single UDP/IP connection to the remote IP media-gateway.

Furthermore, the IP network as described above should be understood also to encompass a case where the local VoIP media-gateway is interconnected with a plurality of remote media-gateways, in which case the local media-gateway may communicate with some or all of the remote media-gateway in accordance with the method provided by the present invention.

Preferably, the identification of a user further comprises a unique channel identifier for each of the two or more users.

According to still another aspect of the invention there is provided an IP packetizer comprising:

means operative to create a composite header for each of a plurality of data packets and to add said composite header to a data packet associated therewith;

multiplexing means operative to multiplex a plurality of communication frames in accordance with the communication protocol described above; and

transmitting means operative to transmit the UDP payload over a single UDP/IP connection.

Also, in accordance with the present invention there is provided a VoIP media-gateway comprising:

means for creating a composite header for each of a plurality of data packets received from a plurality of users, each composite header providing identification of a user associated with a packet;

means for adding each composite header to the data packet associated therewith to form mini packets;

means for multiplexing the mini packets into a UDP payload; and

means for transmitting the UDP payload over a single UDP/IP connection.

### BRIEF DESCRIPTION OF THE DRAWINGS

The present invention will be understood and appreciated more fully from the following detailed description, taken in conjunction with the drawings in which:

FIG. 1 shows an application scenario in which two sides of a communication session are interconnected via an IP network;

FIG. 2 illustrates the application of mini packets in VoIP media-gateways.

FIGS. 3A, 3B and 3C illustrate mini packets according to embodiment of the present invention in transparent and compressed modes;

FIG. 4 illustrates the multiplexing of mini packets in a UDP payload;

FIG. 5 illustrates a layered communication model; and

FIG. 6 illustrates the use of the TIMER-MUX according to the present invention.

### DETAILED DESCRIPTION OF THE INVENTION

In the following description of the exemplary embodiment, reference is made to the accompanying drawings which form a part hereof, and in which is shown by way of illustration the specific embodiment in which the invention may be practiced.

It is to be understood that other embodiments may be utilized, as structural changes may be made without departing from the scope of the present invention.

The present invention provides an efficient method and apparatus for transporting short packets such as compressed speech packets between IP telephony media-gateways connected by an IP network. The present invention enables a number of low bit rate connections (compressed speech) to share a single UDP/IP connection, thus reducing the RTP/UDP/IP overhead. A mini header is added to each packet received from a user before it is assembled with packets from other users into a single UDP payload.

The foregoing description of the exemplary embodiment of the invention is presented for the purposes of illustration and description. It is not intended to be exhaustive or to limit the invention to the precise form disclosed. Many modifications and variations are possible in light of the above teaching.

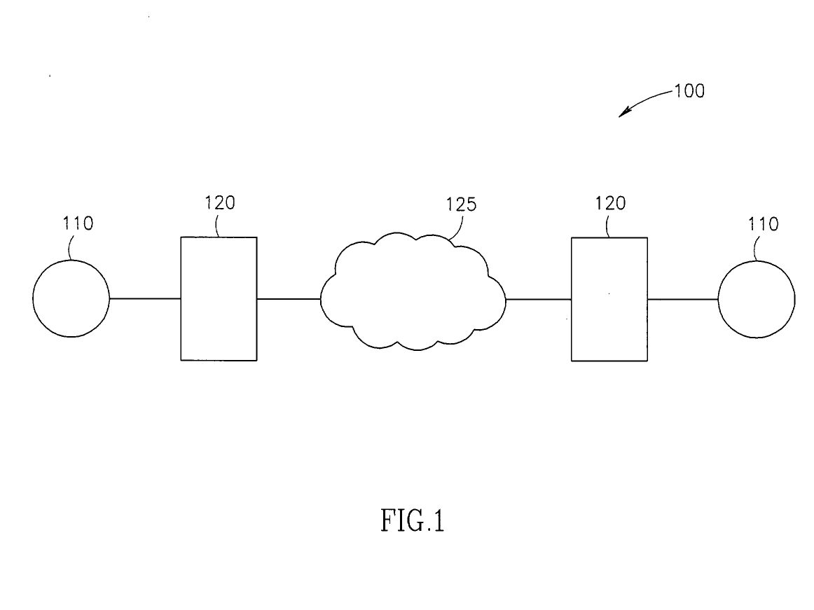

FIG. 1 shows an application scenario 100 in which two user sites 110 are interconnected by media-gateways 120, located at two ends of an IP network 125. In such an application, a telephone call between users 110 located at either side of the media-gateways 120 is carried by a separate RTP/UDP/IP connection. The codecs used at the media-gateway to compress incoming voice calls generate packets with a size typically ranging from 5 to 20 bytes. When using a voice codec operative in accordance with ITU-T Recommendation G.711, the packet size may typically range between 5 to 20 msec (40 to 160 bytes per packet).

For example, the ITU-T Recommendation G.729 specifies a voice compression algorithm that generates 10 bytes every interval of 20 ms speech sample. Typically, two blocks of 10 bytes each, are sent in one IP packet, every 20 msec. Many other voice compression algorithms also generate small packets. However, these small size packets require a large overhead when they are transferred using the Real time Transport Protocol (RTP).

The RTP/UDP/IP overhead is 40 bytes (12+8+20) for each speech packet. For example, if a 20 bytes packet is transferred via RTP/UDP/IP then the overhead is 67%, i.e., 40/(40+20). In addition, for each call request a single UDP/IP connection is established between the media-gateways 120 requiring a large amount of processing and storage in media-gateways 120.

Congestion in IP networks results in packet loss at routers and UDP does not have any retransmission mechanism to recover lost packets. Also, real time applications such as speech are intolerant to delay caused by re-transmission. In a normal RTP method, each individual speech packet is transmitted as an IP packet, which generates a large number of packets between the media-gateways. This heavy traffic volume is a potential situation for congestion and packet loss at IP routers.

The large overhead associated with the transfer of small packets (compressed speech) through RTP/UDP/IP has been one of the drawbacks of IP telephony. In order to minimize the overhead, RTP/UDP/IP header compression is applied.

However, this method requires carrying out compressing/decompressing activities at routers, as well as some additional processing overhead.

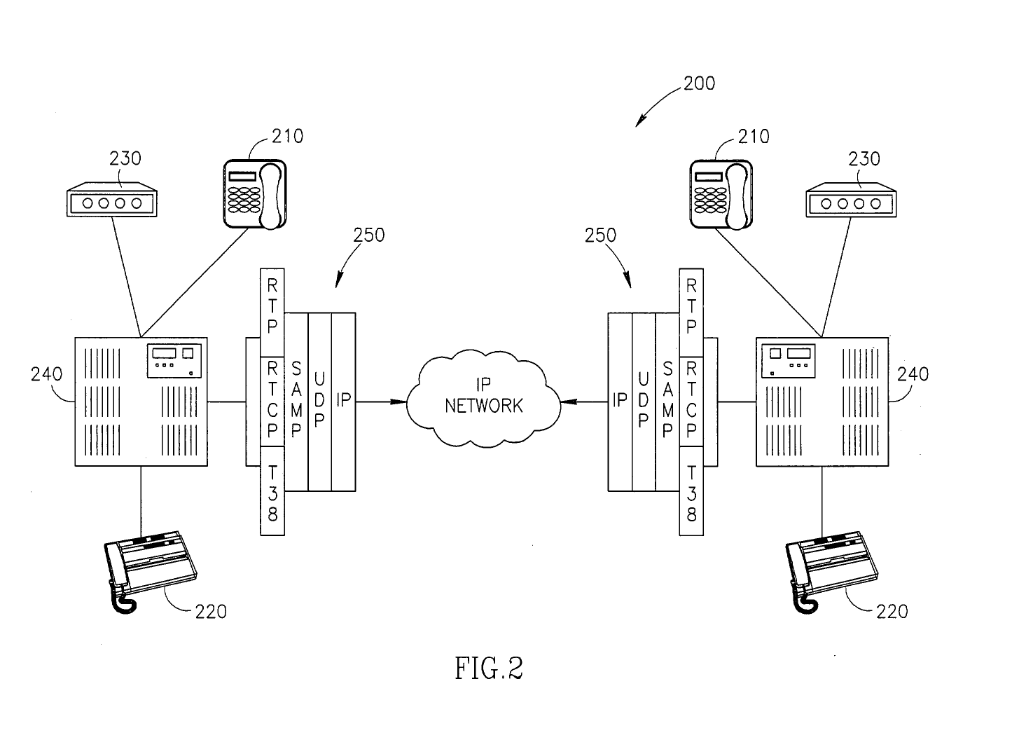

FIG. 2 illustrates a system 200 used in transporting voice communication of users, between IP telephony media-gateways. Traditional telephony users such as telephone users 210, and/or facsimile users 220 and/or modem users 230, interconnected via PBX 240 by IP media-gateways 250 is a typical scenario where mini packets of the present invention improves the bandwidth efficiency of the IP network. Of course other implementations can also be adopted e.g. in wireless networks.

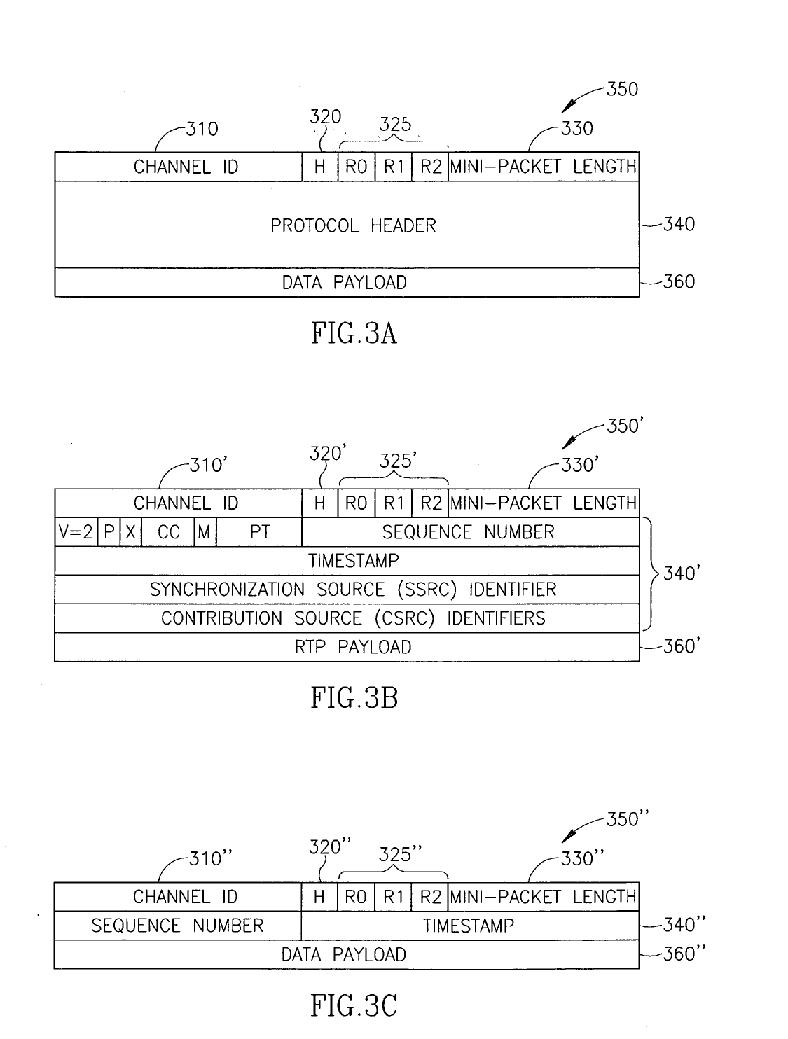

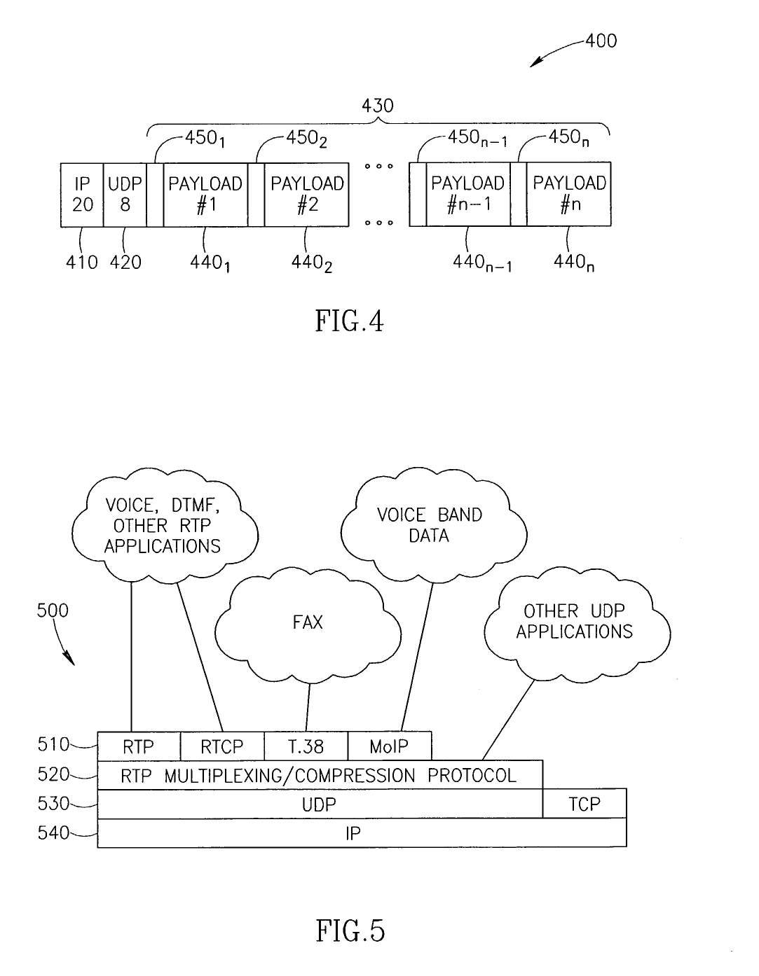

FIGS. 3A to 3C and 4 illustrate mini packets used to improve the bandwidth efficiency in accordance with the communication protocol of the present invention (which for the purpose of convenience will be referred hereinafter as “SAMP”). A typical mini packet comprises a composite header (having a mini header and a protocol header in a compressed/transparent mode) and the application payload. The application payload of the mini packet may carry any type of UDP application protocol (e.g. RTP, RTCP, T.38, Modem over IP etc.). In the example presented in FIG. 3A, the composite header comprises the following:

Channel ID (CID), 310, —2 bytes. This field identifies the user identity of the SAMP channel. Preferably, this field should be copied from the original UDP destination port of the user, which is also 2 bytes long.

Flag, 320, indicating the protocol header mode (H)—1 bit. This 1 bit field is used to identify the mode (format) of SAMP protocol header i.e. transparent or compressed. If the protocol header is not compressed (transparent mode SAMP/RTP Header), as illustrated in FIG. 3A then this bit is set to “0”. If the protocol header is in the compressed mode (Compressed mode SAMP/RTP Header), then this field is set to “1”.

Reserved field (R), 325—3 bits. This field is an optional field and is reserved for future applications, such as for transmission of control information, etc.

Mini packet length indicator (LI), 330—12 bits. This field indicates the length in bytes of the variable size mini packet. A maximum mini-packet size of 4096 bytes is preferred.

Protocol header, 340. Examples for such a protocol header are RTP header, RTCP header, a header as defined in ITU-T Recommendation T.38 or for Modem over IP (“MoIP”) applications. The combination of this composite header with data packet 360, is in fact the mini packet of the present invention.

A more detailed example of a mini packet comprising a mini header in a transparent mode that includes an RTP protocol header as defined in IETF RFC 1889, is presented in FIG. 3B. The mini packet 350′ presented in this Fig. comprises:

Channel ID (CID), 310′,—2 bytes.

Flag, 320′, indicating the protocol header mode (H)—1 bit, which in this case is set to “0”.

Reserved field (R), 325′—3 bits.

Mini packet length indicator (LI), 330′—12 bits.

RTP Header 340′ as defined in RFC1889—although in this Fig. the RTP protocol header is shown as comprising 16 bytes (4 lines of 4 bytes each), still according to IETF RFC 1889, the first twelve bytes are present in every RTP packet, while the 4 bytes long Contribution Source (CSRC) identifiers are present only when inserted by a mixer.

payload of the data packet, 360′.

FIG. 3C illustrates an example of a mini packet 350″ in a compressed mode, comprising:

Mini header:

Channel ID (CID), 310″,—2 bytes.

Flag, 320″, indicating the protocol header mode (H)—1 bit, which in this case is set to “1”.

Reserved field (R), 325″—3 bits.

Mini packet length indicator (LI), 330″—12 bits.

Protocol header 340″: Compressed RTP header field of 4 bytes which comprises:

Sequence number,—12 bits long; and

Timestamp,—20 bits long.

The mini packet further comprises the payload of the data packet, 360″.

It should be appreciated that the purpose of the transparent mode is to provide simple and transparent transmission of the RTP header. However, in alternative embodiments, any of the Sequence number and the Timestamp may be presented in the compressed mode by different numbers of bits, as long as this presentation requires less than the original number of bits thereof.

FIG. 4 illustrates an IP packet 400, which comprises a communication frame (a SAMP frame) of the present invention. Packet 400 comprises:

a 20 bytes IP header field, 410;

a 8 bytes UDP header field, 420; and

a SAMP frame, 430.

The SAMP frame 430 comprise a number of concatenated mini packets 440_{1, 2 . . . , n}, each with its corresponding composite header 450_{1, 2 . . . , n}, respectively, and where each of the mini packets may carry a different protocol. The SAMP frame has a predefined maximum size (MAX-FRAME_SIZE). In order to avoid segmentation, this size shall preferably not exceed 1500 bytes.

Configuration management shall preferably also predefine a maximum timer (TIMER-MUX) for SAMP frame aggregation. This timer ensures that a maximum packet delay is not exceeded during low channel activity periods.

Transmission of the SAMP frame to the corresponding far end media-gateway could be triggered by any of the following conditions:

if the maximum defined SAMP frame size has been reached or has been exceeded; or

if the SAMP aggregation timer has expired.

Now let us revert to a typical communication procedure carried out in accordance with the present invention.

Transmitter Side:

When a channel is operating with protocol header compression the transmitter will alternate the SAMP mini packet format between transparent mode mini packets and compressed mode mini packets.

The transparent mode RTP header shall be applied in the following cases:

at the beginning of a new call;

when a change takes place in the RTP fixed header fields excluding sequence number and timestamp fields; or

when a configurable timer “RTP header refresh—timer” has expired.

In order to provide robustness against packet losses at the IP network, the transparent protocol header mode shall preferably be applied at least N times consecutively (e.g. N is equal to 2 or 3 times). More preferably, the number N shall be a configurable parameter and be determined to match the required IP network performance.

The compressed RTP header shall be applied in all cases when there is no need to send packets at the transparent mode as defined above.

Receiver Side:

When a channel is operated in accordance with the present invention, the receiver shall be capable of receiving both transparent mode mini packets as well as compressed mode mini packets.

While receiving compressed mode mini packets, the receiver shall retrieve the missing information fields of the protocol header from the last received transparent mini packet and reconstruct the non-compressed RTP header.

The following are some examples demonstrating the advantages that may be achieved by using the present invention. In these examples, the bandwidth efficiency is defined as useful payload/total payload (which includes all overheads associated with the transfer of the useful payload).

1) Use of non-multiplexed flows as demonstrated in one of the prior art solutions:

The calculated efficiency is equal to:

Payload/(IP+UDP+RTP headers+RTP payload data)

For G.729 with 20 msec packets (20 bytes), the resulting efficiency is 33%.

2) Use of the composite headers of the present invention while all mini packets are transmitted in a transparent mode:

when multiplexing G.729 compressed voice sources of 20 msec packets (20 bytes) the bandwidth efficiency is calculated to be:

10 G.729 channels multiplexed:bandwidth efficiency=51%

100 G.729 channels multiplexed:bandwidth efficiency=55%

3) Use of the composite headers of the present invention while applying the compressed mode when possible:

when multiplexing constant bit rate G.729 compressed voice sources of 20 msec packets (20 bytes) the bandwidth efficiency is calculated to be:

10 G.729 channels multiplexed:bandwidth efficiency=63%

100 G.729 channels multiplexed:bandwidth efficiency=71%

wen Voice Activity Detector (VAD) is used with G.729 codecs, a typical voice activity period is of 400 msec. A 400 msec period consists of 20 G.729 packets of 20 bytes each. Assuming that the first three packets are transmitted with a transparent RTP header and the rest of 17 packets are transmitted with compressed RTP header, the calculated bandwidth efficiency would be:

when 10 channels with voice activity are multiplexed: the bandwidth efficiency=61%.

when 100 channels with voice activity are multiplexed: the bandwidth efficiency=69%.

FIG. 5 illustrates a layered communication model 500 constructed in accordance with the method of the present invention. At the uppermost layer of the seven layers ISO model, 510, the optional payloads are presented: voice, DTMF and other RTP compatible applications (constructed in accordance with RTP/RTCP protocols, facsimile (in accordance with T.38 Recommendation), and voiceband data (in accordance with MOIP). These payloads ride an intermediate layer 520 and optionally together with other UDP applications ride the forth layer 530, preferably together with TCP. These in turn are transported over the third layer, the IP layer 540.

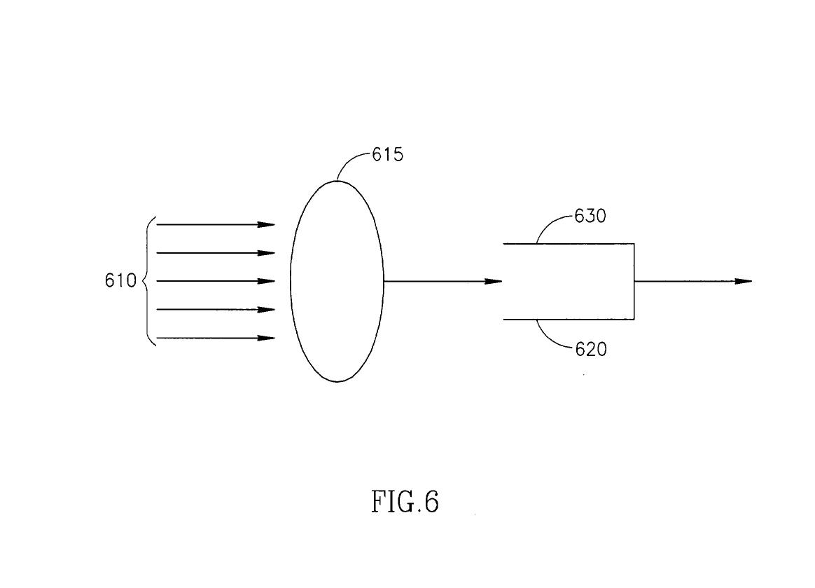

FIG. 6 illustrates the use of the TIMER-MUX according to the present invention. In FIG. 6, mini-packets 610 are received at a scheduler 615. The scheduler schedules packets for assembly into a UDP payload by placing packets into a packet assembly buffer 620. Upon expiration of the TIMER-MUX 630, a UDP packet is transmitted. The TIMER-MUX value depends on the link speed and transfer delay. The higher the TIMER-MUX value the better the bandwidth efficiency. However, a higher TIMER-MUX value could increase the delay for voice packets.

It will be appreciated that the above-described methods may be varied in many ways, including but not limited to, changing the exact implementation used. It should also be appreciated that the above described description of methods and networks are to be interpreted as including network in which the methods are carried out and methods of using the network components.

The present invention has been described using non-limiting detailed descriptions of preferred embodiments thereof that are provided by way of example and are not intended to limit the scope of the invention. It should be understood that features described with respect to one embodiment may be used with other embodiments and that not all embodiments of the invention have all the features shown in a particular figure. Variations of embodiments described will occur to persons of the art. Furthermore, the terms “comprise”, “include”, “have” and their conjugates shall mean, when used in the claims “including but not necessarily limited to”.

1. A communication frame adapted to be used as a UDP payload, wherein said communication frame comprises a plurality of mini packets, and wherein at least some of said mini packets comprise:
a composite header which comprises:
a protocol header; and
a mini header comprising:
an identification of a user associated with a data packet;
a flag indicating whether said protocol header is in a compressed mode or is in a transparent mode;
an indication of the length of said mini packet; and
a data packet.

2. A communication protocol of claim 1, wherein said identification of a user associated with a data packet is a 2 byte long channel ID.

3. A communication protocol of claim 1, wherein said identification of a user associated with a data packet comprises the number of the port through which said data packet is transmitted.

4. A communication protocol of claim 1, comprising at least one mini packet having a protocol header in a transparent mode and wherein said protocol header is a member of the group consisting of: an RTP header, an RTCP header, a T.38 header and a MOIP header.

5. A communication protocol of claim 4, wherein said protocol header is an RTP header as defined in IETF RFC 1889.

6. A communication protocol of claim 1, comprising at least one mini packet having a protocol header in a compressed mode and wherein said protocol header comprises an indication of a sequential number of a data packet associated therewith and an indication of time in which said data packet is transmitted.

7. A communication protocol of claim 6, wherein said indication of the sequential number of a data packet is less than 16 bits long.

8. A communication protocol of claim 6, wherein said indication of time is less than 32 bits long.

9. A communication protocol according to claim 6, wherein said indication of said sequential number comprises the least significant bits of the sequential number and wherein said indication of time comprises the least significant bits of said indication of time.

10. A communication protocol according to claim 6, wherein the mode of each of the protocol headers of said plurality of mini packets is determined by at least one of the following criteria:
a protocol header of the mini packet transmitted at a beginning of a communication session, shall be transmitted in a transparent mode; and
whenever the information in a protocol header is different only in the sequence number and time stamp from the information included in the protocol header of the preceding mini packet and received from the same user, the protocol header shall be transmitted in a compressed mode; and
if all mini packets associated with a user were transmitted for a predetermined time with their protocol headers being in a compressed mode, the protocol header of the proceeding mini packet shall be transmitted in a transparent mode.

11. A communication protocol according to claim 10, further comprising transmitting at least two consecutive mini packets each having a protocol header in a transparent mode.

12. A protocol according to claim 1, wherein said communication frame comprises a plurality of mini packets, wherein each mini packet comprises a composite header and a data packet.

13. A protocol according to claim 1, wherein said communication frame further comprises at least one frame header.

14. A protocol according to claim 13, wherein said at least one frame header is used to carry information that relates to proceeding mini packets that follow said frame header.

15. A method for increasing bandwidth usage efficiency of an IP network comprising:
creating a composite header for each of a plurality of data packets, each composite header comprises a mini header providing identification of a user associated with a data packet and a protocol header;
adding each composite header to the data packet associated therewith to form a mini packet;
multiplexing a plurality of mini packets into a UDP payload; and
transmitting the UDP payload over a single UDP/IP connection.

16. The method of claim 15, wherein the plurality of data packets are received from two or more users.

17. The method of claim 16, wherein the identification of a user further comprises a unique channel identifier for each of two or more users.

18. The method of claim 17, wherein said channel identifier is assigned to packets transmitted from a user when the user requests access to the IP network.

19. The method of claim 17, wherein at least one of said plurality of data packets is an RTP packet, comprising voice information.

20. The method of claim 15, wherein at least one of said plurality of data packets is a data packet that is compatible with ITU Recommendation T.38 and carries a facsimile signal.

21. A method according to claim 15, wherein the composite header of each data packet multiplexed into said UDP payload is transparent to intermediate IP routers.

22. A method according to claim 15, further comprising de-assembling the UDP payload back into the data packets.

23. An IP network, comprising:
a local VoIP media-gateway; and
at least one remote VoIP media-gateway;
wherein the local and said at least one remote VoIP media-gateways communicate using a protocol, the protocol comprising:
creating a composite header for each of a plurality of data packets received from a plurality of users at the local VoIP media-gateway, each composite header comprises a mini header providing identification of a user associated with a packet and a protocol header;
adding each composite header to the data packet associated therewith to form a mini packet;
multiplexing a plurality of mini packets into a UDP payload;
and transmitting the UDP payload over a single UDP/IP connection to a corresponding remote VoIP media-gateway.

24. The IP network of claim 23, wherein the identification of a user further comprises a unique channel identifier for each of the two or more users.

25. An IP packetizer comprising:
means operative to create a composite header which comprises a mini header and a protocol header for each of a plurality of data packets and to add said composite header to a data packet associated therewith;
multiplexing means operative to multiplex a plurality of communication frames; and
transmitting means operative to transmit the UDP payload over a single UDP/IP connection.

26. A VoIP media-gateway comprising:
means for creating a composite header which comprises a mini header providing identification of a user associated with a packet and a protocol header, for each of a plurality of data packets received from a plurality of users;
means for adding each composite header to the data packet associated therewith to form a mini packet;
means for multiplexing a plurality of mini packets obtained into a UDP payload; and
means for transmitting the UDP payload over a single UDP/IP connection.
